(19) United States
(12) Patent Application Publication
(10) Pub. No.: US 2019/0002702 A1
(43) Pub. Date: Jan. 3, 2019

(54) CARBON BLACK COMPOSITION WITH SULFUR DONER

(71) Applicant: Columbian Chemicals Company, Marietta, GA (US)

(72) Inventors: Charles R. Herd, Marietta, GA (US); Zachary A. Combs, Marietta, GA (US)

(21) Appl. No.: 16/062,654

(22) PCT Filed: Dec. 15, 2016
(86) PCT No.: PCT/US2016/066920

§ 371 Date: Jun. 15, 2018

Related U.S. Application Data
(60) Provisional application No. 62/267,525, filed on Dec. 15, 2015.

(51) Int. Cl. C09C 1/56; C09C 3/08; C09C 3/10; C08K 3/04; B60C 1/00

(52) U.S. Cl. CPC C09C 1/565; C09C 3/08; C09C 3/10; C01P 2006/19; B60C 1/0016; C01P 2006/12; C08K 3/04

(57) ABSTRACT

Carbon black composition with a sulfur donor, and elastomeric compositions comprising the same, together with methods for preparing and using the same.

### CROSS REFERENCE TO RELATED APPLICATIONS

The present application claims the benefit of priority to U.S. Provisional Patent Application 62/267,525, filed on Dec. 15, 2015, all of which applications are incorporated herein fully by this reference.

### BACKGROUND

### Technical Field

The present disclosure relates to carbon black compositions comprising a sulfur donor, to elastomeric compositions comprising the same, together with methods for the manufacture and use of both the carbon black compositions and elastomeric compositions.

### Technical Background

Carbon black is frequently used as a reinforcing filler in elastomeric systems. When these elastomeric compositions, such as a rubber compound, are mixed, sulfur or sulfur containing compounds are frequently added as cure agents/crosslinkers. To improve interaction between the carbon black and the elastomer, efforts have been undertaken to combine carbon blacks with functionalized elastomer compositions. While the use of such functionalized elastomer compositions can provide improved properties and performance, the technology requires an optimized polymer microstructure and functionalization, potentially limiting wide applicability of this technology.

Thus, there is a need for improved carbon black materials and elastomeric compositions comprising the same. These needs and other needs are satisfied by the compositions and methods of the present disclosure.

### SUMMARY

In accordance with the purpose(s) of the invention, as embodied and broadly described herein, this disclosure, in one aspect, relates to carbon black and elastomeric materials, together with methods for the manufacture and use thereof.

In one aspect, the present disclosure provides a carbon black composition comprising a sulfur donor.

In another aspect, the present disclosure provides a carbon black composition comprising a sulfur donor compound having at least one electronegative group.

In another aspect, the present disclosure provides a carbon black composition comprising a sulfur donor containing thiophosphate.

In another aspect, the present disclosure provides an elastomer composition comprising a carbon black composition comprising a sulfur donor.

In yet another aspect, the present disclosure provides methods for preparing carbon black compositions comprising a sulfur donor.

In yet another aspect, the present disclosure provides methods for preparing elastomer compositions comprising a carbon black and a sulfur donor.

In yet another aspect, the present disclosure provides methods for preparing elastomer compositions comprising a carbon black comprising a sulfur donor.

The accompanying figures, which are incorporated in and constitute a part of this specification, illustrate several aspects and together with the description serve to explain the principles of the invention.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several aspects and together with the description serve to explain the principles of the invention.

FIG. 1 illustrates the Mooney viscosity of various passenger car radial (PCR) formulations, in accordance with various aspects of the present disclosure.

FIG. 2 illustrates optimal vulcanization time (T90) for various PCR formulations, in accordance with various aspects of the present disclosure.

FIG. 3 illustrates bound rubber values for various PCR formulations, in accordance with various aspects of the present disclosure.

FIG. 4 illustrates the modulus build for various PCR formulations, in accordance with various aspects of the present disclosure.

FIG. 5 illustrates rebound values at 25° C. for various PCR formulations, in accordance with various aspects of the present disclosure.

FIG. 6 illustrates the heat buildup for various PCR formulations, in accordance with various aspects of the present disclosure.

FIG. 7 illustrates the change in Payne Effect for various PCR formulations, in accordance with various aspects of the present disclosure.

FIG. 8 illustrates the change in tan delta for various PCR formulations, in accordance with various aspects of the present disclosure.

FIG. 9 illustrates dispersion index values for various truck/bus radial (TBR) formulations, in accordance with various aspects of the present disclosure.

FIG. 10 illustrates Mooney viscosity values for various TBR formulations, in accordance with various aspects of the present disclosure.

FIG. 11 illustrates T90 cure times for various TBR formulations, in accordance with various aspects of the present disclosure.

FIG. 12 illustrates crosslink density for various TBR formulations, in accordance with various aspects of the present disclosure.

FIG. 13 illustrates modulus build for various TBR formulations, in accordance with various aspects of the present disclosure.

FIG. 14 illustrates rebound values at 60° C. for various TBR formulations, in accordance with various aspects of the present disclosure.

FIG. 15 illustrates the heat buildup for various TBR formulations, in accordance with various aspects of the present disclosure.

FIG. 16 illustrates the Vieth tear strength for various TBR formulations, in accordance with various aspects of the present disclosure.

FIG. 17 illustrates the Knotty tear index for various TBR formulations, in accordance with various aspects of the present disclosure.

FIG. 18 illustrates the change in Payne Effect for various TBR formulations, in accordance with various aspects of the present disclosure.

FIG. 19 illustrates the change in tan delta for various TBR formulations, in accordance with various aspects of the present disclosure.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used herein, unless specifically stated to the contrary, the singular forms “a,” “an” and “the” include plural references unless the context clearly dictates otherwise. Thus, for example, reference to “a filler” or “a solvent” includes mixtures of two or more fillers, or solvents, respectively.

As used herein, unless specifically stated to the contrary, the abbreviation “phr” is intended to refer to parts per hundred, as is typically used in the rubber industry to describe the relative amount of each ingredient in a composition.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As briefly described above, the present disclosure provides carbon black compositions comprising a sulfur donor, together with elastomeric compositions comprising such carbon black compositions, and methods for manufacturing and using both the carbon black compositions and the elastomeric compositions. Prior efforts to improve the interaction between carbon black and elastomeric materials have employed functionalized elastomers, wherein specific functional groups interact with functional groups on the carbon black surface. Such functionalized polymers include functioalizations not present in standard NR/BR/SBR type elastomer used in the rubber industry. In contrast, the inventive approach described herein comprises the use of a carbon black composition comprising a sulfur donor, wherein the resulting carbon black composition can be used with standard (i.e., unmodified and/or non-functionalized) elastomer materials. The inventive combinations can also be utilized with functionalized elastomers alone or in combination with standard unmodified elastomer materials. In various aspects, the resulting elastomeric compositions can provide reduced rolling resistance, as compared to conventional carbon black/elastomer compositions. In other aspects, the resulting elastomeric compositions can provide other improved mechanical properties, such as, for example, tear strength and/or heat buildup. In various aspects, the elastomer can comprise any one or more elastomers, including functionalized and non-functionalized elastomers, for example, functionalized SBR, non-functionalized SBR, natural rubber, and butadiene rubber.

The carbon black of the present invention can comprise any carbon black suitable for use with the sulfur donor compound and/or elastomeric materials employed. In one aspect, the carbon black is a furnace carbon black. In another aspect, the carbon black can be functionalized. In yet another aspect, the carbon black can be non-functionalized. In one aspect, use of a sulfur donor with a functionalized carbon black can reduce and/or eliminate the need for a functionalized elastomer. In one aspect, a functionalized carbon black with a sulfur donor can be used with a non-functioanlized elastomer. In another aspect, a functionalized carbon black can be used with a functionalized elastomer. In one aspect, a functionalized carbon black can comprise an oxidized surface having at least about 3 wt %, at least about 4 wt %, at least about 4.5 wt %, at least about 5 wt %, or higher volatile content. In other aspects, such an oxidized carbon black can be prepared by any means suitable, such as, for example, treatment with acid, ozone, peroxide, alcohol, or combinations thereof.

The carbon black can have a nitrogen surface area, as determined by, for example, ASTM Method D6556-14, of from about 15 m²/g to about 140 m²/g; from about 20 m²/g to about 130 m²/g; from about 30 m²/g to about 135 m²/g; from about 40 m²/g to about 110 m²/g; from about 50 m²/g to about 140 m²/g; from about 60 m²/g to about 125 m²/g; from about 70 m²/g to about 130 m²/g; from about 80 m²/g to about 110 m²/g; from about 95 m²/g to about 135 m²/g; from about 100 m²/g to about 130 m²/g; from about 105 m²/g to about 125 m²/g; from about 110 m²/g to about 125 m²/g; from about 115 m²/g to about 125 m²/g; from about 110 m²/g to about 120 m²/g; from about 115 m²/g to about 120 m²/g; from about 115 m²/g to about 121 m²/g; or from about 116 m²/g to about 120 m²/g. In another aspect, the carbon black can have a nitrogen surface area of about 15, 17, 18, 19, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, 98, 100, 102, 104, 106, 108, 110, 112, 114, 116, 118, 120, 122, 124, 126, 128, 130, 132, 134, 136, 138, or 140 m²/g. In yet another aspect, the carbon black can have a nitrogen surface area of about 116 m²/g or of about 118 m²/g. In other aspects, the carbon black of the present invention can have a nitrogen surface area greater than or less than any value specifically recited herein, and the present invention is not intended to be limited to any particular nitrogen surface area value.

The carbon black can have an external surface area, based on the statistical thickness method (STSA, ASTM D6556-14), of from about 10 m²/g to about 140 m²/g; from about 15 m²/g to about 125 m²/g; from about 25 m²/g to about 135 m²/g; from about 30 m²/g to about 115 m²/g; from about 40 m²/g to about 140 m²/g; from about 50 m²/g to about 130 m²/g; from about 60 m²/g to about 110 m²/g; from about 70 m²/g to about 125 m²/g; from about 80 m²/g to about 125 m²/g; from about 85 m²/g to about 120 m²/g; from about 90 m²/g to about 115 m²/g; from about 95 m²/g to about 110 m²/g; from about 95 m²/g to about 105 m²/g; from about 98 m²/g to about 104 m²/g; or from about 99 m²/g to about 103 m²/g. In another aspect, the carbon black can have an external surface area of about 10, 11, 13, 15, 17, 18, 19, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, 98, 100, 102, 104, 106, 108, 110, 112, 114, 116, 118, 120, 122, 124, 126, 128, 130, 132, 134, 136, 138, or 140 m²/g. In another aspect, the carbon black can have an external surface area of about 101 m²/g. In various aspects, the external surface area of a carbon black is the specific surface area that is accessible to a rubber compound. In other aspects, the carbon black of the present invention can have an external surface area greater than or less than any value specifically recited herein, and the present invention is not intended to be limited to any particular external surface area value.

The carbon black of the present invention can have an oil absorption number (OAN), as measured by, for example, ASTM Method D2414-16e1, of from about 40 cm³/100 g to about 180 cm³/g, for example, about 40, 45, 50, 55, 60, 65, 70, 75, 80, 85, 90, 95, 100, 105, 110, 115, 120, 125, 130, 135, 140, 145, 150, 155, 160, 165, 170, 175, or 180 cm³/100 g; from about 125 cm³/g to about 140 cm³/g; from about 80 cm³/g to about 130 cm³/g; from about 95 cm³/100 g to about 140 cm³/100 g; from about 95 cm³/100 g to about 125 cm³/100 g; from about 105 cm³/100 g to about 140 cm³/100 g; for example, about 95, 97, 99, 101, 103, 105, 107, 109, 111, 113, 115, 117, 119, 121, 123, 125, 127, 129, 131, 133, 135, 137, 139, or 140 cm³/100 g. In another aspect, the carbon black of the present invention can have a compressed oil absorption number (COAN), as measured by, for example, ASTM Method D3493-16, of from about 40 cm³/100 g to about 125 cm³/100 g, for example, about 40, 45, 50, 55, 60, 65, 70, 75, 80, 85, 90, 95, 100, 105, 110, 115, 120, or 125 cm³/100 g; from 85 cm³/100 g to about 115 cm³/100 g; from about 85 cm³/100 g to about 110 cm³/100 g; from about 85 cm³/100 g to about 105 cm³/100 g; from about 90 cm³/100 g to about 115 cm³/100 g; from about 95 cm³/100 g to about 115 cm³/100 g; from about 105 cm³/g to about 115 cm³/g; or from about 90 cm³/100 g to about 110 cm³/100 g; for example, about 85, 87, 89, 91, 93, 95, 97, 99, 101, 103, 105, 107, 109, 111, 113, or 115 cm³/100 g. In other aspects, the carbon black of the present invention can have an oil absorption number and/or a compressed oil absorption number greater than or less than any value specifically recited herein, and the present invention is not intended to be limited to any particular external surface area value.

The carbon black of the present invention can have a pH, as measured by, for example, ASTM Method D1512-15 using either Test Method A or Test Method B, of from about 1 to about 14; from about 2 to about 12; from about 2 to about 7; from about 2.5 to about 4; from about 2.8 to about 3.6; or from about 3 to about 3.4. In another aspect, the carbon black of the present invention can have a pH of about 3.2. In other aspects, the carbon black of the present invention can have a pH greater than or less than any value specifically recited herein, and the present invention is not intended to be limited to any particular pH value.

The carbon black of the present invention can have a void volume, as determined by, for example, ASTM D7854 or ASTM Method D6086-09a, of from about 55 cm³/100 g to about 67 cm³/100 g (50 GM); from about 60 cm³/100 g to about 65 cm³/100 g (50 GM); from about 50 cm³/100 g to about 60 cm³/100 g (75 GM); from about 53 cm³/100 g to about 58 cm³/100 g (75 GM); from about 45 cm³/100 g to about 55 cm³/100 g (100 GM); or from about 47 cm³/100 g to about 53 cm³/100 g (100 GM). In another aspect, the carbon black can have a 50 GM void volume of about 62.2 cm³/100 g; a 75 GM void volume of about 55.3 cm³/100 g; and/or a 100 GM void volume of about 50.4 cm³/100 g. In other aspects, the void volume of a carbon black can be greater than or less than any value specifically recited herein, and the present invention is not intended to be limited to any particular void volume.

The carbon black of the present invention can have a moisture content, as measured by, for example, ASTM Method D1509-15, of from about 0.5 wt % to about 10 wt %, from about 1 wt % to about 8 wt %, from about 2 wt % to about 6 wt %; from about 2.5 wt % to about 4.5 wt %; from about 3 wt % to about 4 wt %; or from about 3.2 wt % to about 3.8 wt %. In another aspect, the carbon black of the present invention can have a moisture content of about 3.5 wt %. It should be understood that the moisture content of carbon black materials can change, depending upon, for example, environmental and/or storage conditions, and as such, the particular moisture content of a given sample of carbon black can vary. In other aspects, the carbon black of the present invention can have a moisture content greater than or less than any value specifically recited herein, and the present invention is not intended to be limited to any particular moisture content value.

In one aspect, the carbon black of the present invention is an oxidized carbon black, such as, an oxidized furnace carbon black. Various methods exist to oxidize carbon blacks, such as, for example, ozonation, and the particular method for oxidizing a carbon black can vary, provided that a plurality of desired oxygen containing functional groups are present on the surface of the carbon black. In one aspect, the carbon black has been oxidized by treatment with ozone, but the carbon black is not limited to surface modified carbon blacks, or to oxidized carbon blacks, and practically any functionality can be considered as potentially suitable for the inventive material combination and its efficiency.

The carbon black of the present invention can have a volatile content of from about 1 wt % to about 7 wt %; from about 2 wt % to about 7 wt %; from about 3 wt % to about 6.5 wt %; from about 4 wt % to about 6 wt %; from about 4.5 wt % to about 6.5 wt %; from about 5 wt % to about 6 wt %; or from about 5.2 wt % to about 5.8 wt %. In another aspect, the carbon black of the present invention can have a volatile content of at least about 4.5 wt %, at least about 5 wt %, at least about 5.5 wt %, or higher. In another aspect, the carbon black of the present invention can have a volatile content of about 5.5 wt %. In still other aspects, the volatile content of a carbon black can be greater than or less than any value specifically recited herein, and the present invention is not intended to be limited to any particular volatile content value. In one aspect, volatile content can be measured by filling a self sealing, quartz crucible of known weight with carbon black, and placing in an oven at 125° C. with the lid off for 1 hour. The crucible can then be removed and placed in a dessicator while cooling to room temperature. The cooled and dried crucible can then be weighed, after which, the crucible can be placed in a muffle furnace at 950° C. for 15 minutes. The crucible can then be removed and cooled again in a dessicator. For low density and/or powdered carbon black samples, the carbon black sample can be compressed prior to heating. The volatile content is defined as the weight of the heated (i.e., devolatilized) carbon black divided by the weight of the dried (i.e., at 125° C.) carbon black, multiplied by 100.

The carbon black of the present invention can have an oxygen content of from about 0.5 wt % to about 6 wt %; from about 1 wt % to about 6 wt %; from about 1.5 wt % to about 6 wt %; from about 2 wt % to about 6 wt %; from about 2.5 wt % to about 5.5 wt %; from about 3 wt % to about 5 wt %; from about 3.5 wt % to about 4.5 wt %; or from about 3.7 wt % to about 4.3 wt %. In another aspect, the carbon black of the present invention can have an oxygen of at least about 3.5 wt %, at least about 4 wt %, or higher. In another aspect, the carbon black of the present invention can have an oxygen content of about 4 wt %. In still other aspects, the oxygen content of a carbon black can be greater than or less than any value specifically recited herein, and the present invention is not intended to be limited to any particular oxygen content value. In one aspect, oxygen content can be determined using an EMGA-820 Oxygen/Nitrogen analyzer, available from Horiba Scientific, Edison, N.J., USA. This technique utilizes an impulse furnace, which applies electric current through a graphite crucible to rapidly heat the crucible and carbon black sample. The carbon black sample undergoes thermal decomposition and the resulting gases are analyzed by a non-dispersive infrared detector and a thermal conductivity detector. A glass scintillation vial can be partially filled with carbon black and dried in a vacuum oven overnight at 120° C. 30 mg of the dried carbon black can then be placed in a nickel capsule and pressed to close. The closed capsule is then analyzed to determine oxygen content.

In one aspect, a carbon black can have one or more of a nitrogen surface area of from about 112 m²/g to about 120 m²/g, an external surface area of from about 97 m²/g to about 105 m²/g, a heat loss of from about 3.1 wt % to about 3.9 wt %, an oil absorption number of from about 106 cm³/100 g to about 114 cm³/100 g, a compressed oil absorption number of from about 91 cm³/100 g to about 99 cm³/100 g, a void volume (75 GM) of from about 51 cm³/100 g to about 59 cm³/100 g, and a volatile content of from about 5.1 wt % to about 5.9 wt %. In another aspect, a carbon black can have one or more of a nitrogen surface area of about 116 m²/g, an external surface area of about 101 m²/g, a heat loss of about 3.5 wt %, an oil absorption number of about 110 cm³/100 g, a compressed oil absorption number of about 95 cm³/100 g, a voil volume of about 55 cm³/100 g, and a volatile content of about 5.5 wt %. In another aspect, a carbon black can have one or more of a nitrogen surface area of about 115 m²/g, an external surface area of about 108 m²/g, a heat loss of about 0.5 wt %, a volatile content of about 1.5 wt %, an oil absorption number of about 125 cm³/100 g, a compressed oil absorption number of about 102 cm³/100 g, and a void volume (75 GM) of about 60 cm³/100 g. In another aspect, a carbon black can have two or more of the properties recited above. In other aspects, a carbon black can have three, four, five, or more of the properties recited above. In one aspect, the carbon black can comprise a CD2125XZ carbon black having a nitrogen surface area of about 116 m²/g, an external surface area of about 101 m²/g, a heat loss of about 3.5 wt %, a volatile content of about 5.5 wt %, and a void volume of about 55 cm³/100 g.

In one aspect, any recitation in the specification and examples to a specific grade carbon black is intended to also refer to any other grade carbon black suitable for use in the intended application. For example, any recitation of CD2125XZ is also intended to refer to other carbon blacks, including other oxidized carbon blacks suitable for use in the elastomer compounds described herein. Similarly, reference to an N234 grade carbon black can also refer to other carbon blacks, for example, conventionally used in tire formulations.

The sulfur donor of the present invention can comprise any sulfur containing material capable of interacting with the carbon black and providing one or more of the desired performance improvements when compounded with an elastomer.

Conventional sulfur donor used in elastomeric materials are organic compounds that contain sulfur in a thermally labile form, wherein the sulfur can be released under normal curing conditions for the elastomer compound. These conventional sulfur donors are typically added during the compounding of the elastomer materials to accelerate the cure and/or to provide a balance of viscoelastic properties in tire compounds. In contrast, the sulfur donor of the present invention can be contacted with the carbon black to provide a carbon black composition prior to compounding. In one aspect, the sulfur donor interacts with one or more functional groups on the surface of the carbon black.

In other aspects, the sulfur donor does not generate nitrosamine compounds when contacted with carbon black and/or an elastomer material. In such an aspect, the use of a sulfur donor as described herein can provide a nitrosamine free cure system.

In one aspect, the sulfur donor comprises a sulfide and/or a polysulfide. In another aspect, the sulfur donor comprises a disulfide bond. In another aspect, the sulfur donor comprises a trisulfide bond. In yet another aspect, the sulfur donor comprises sulfur that can be liberated during a subsequent processing and/or compounding step to accelerate or participate in the cure of the elastomer materials.

In one aspect, the sulfur donor comprises sulfur and one or more electronegative groups. In various aspects, electronegative groups, such as, for example, phosphate groups, can interact with functional groups on the carbon black surface. In one aspect, the sulfur donor comprises at least one electronegative group. In another aspect, the sulfur donor comprises at least two electronegative groups of the same or differing type. In various aspects, the electronegative group can have an electronegativity of at least about 1.8, at least about 2, or at least about 2.19 (on the Paulding scale). In other aspects, the electronegative group can act as a leaving group.

In another aspect, at least one electronegative group comprises a phosphate. In still another aspect, the sulfur donor comprises two phosphate groups. In one aspect, the sulfur donor comprises a thiophosphate. In another aspect, the sulfur donor comprises a dithiophosphate. In still another aspect, the sulfur donor comprises an organothiophosphate. In another aspect, the sulfur donor can comprise one or more hydrocarbon chains attached to one or more of the thiophosphate groups. In another aspect, the sulfur donor is a phosphoryl polysulfide.

While not wishing to be bound by theory, it is believed that the phosphate moieties of the sulfur donor can interact with oxygen containing functional groups, such as, for example, alcohol, hydroxyl and/or carboxylic acids, on the carbon black surface in a phosphoryl transfer reaction. In such a reaction, the sulfur donor can act as a coupling agent between the carbon black and an elastomer during a subsequent processing and/or compounding step.

The sulfur donor of the present invention can be utilized in its neat form, for example, as a liquid, or distributed on a support, such as, for example, a silica support, or it can be, for example, sprayed on and distributed on the carbon black itself.

In another aspect, the sulfur donor can comprise RHENOGRAN SDT, RHENOGRAN SDT-50, and/or RHENOGRAN SDT/S, available from Rhein Chemie Corporation, 145 Parker Court, Chardon, Ohio, USA. In one aspect, RHENOGRAN SDT/S is 70% phosphoryl polysulfide carried on the surface of 30% high activity silica. In another aspect, the sulfur donor can comprise a caprolactam disulfide, such as, for example, RHENOGRAN® CLD-80, also available from Rhein Chemie. In one aspect, any reference to SDT and/or RHENOGRAN, is also intended to refer to any suitable sulfur donor, including, for example, other versions of a RHENOGRAN material (e.g., RHENOGRAN SDT, SDT-50, SDT/S, etc.).

In one aspect, the sulfur donor can be contacted with carbon black prior to contact with an elastomer material. In another aspect, the sulfur donor can be added to, for example, a mixer, in a processing or compounding step. In various aspects, the mixing protocol for a carbon black, sulfur donor, and/or elastomer can comprise a traditional mixing protocol for the rubber compounding industry or a reactive mixing protocol. In one aspect, the sulfur donor can be added at a time earlier than when a cure accelerator would typically be added, such as, for example, concurrently with or directly after addition of all or a portion of carbon black. In another aspect, the sulfur donor can be added after the carbon black, but prior to the time period when a cure accelerator would be added. In this manner, the sulfur donor can act as a coupling agent between the carbon black and an elastomer.

The amount of sulfur donor contacted with carbon black and/or an elastomer can be any amount suitable for use with the carbon black and/or elastomer to provide one or more desired properties. In one aspect, a sulfur donor carried on the surface of a carbon black can provide a greater level of enhancement for a desired property than can normally be achieved by simple addition to the mix. Accordingly, in one aspect, less sulfur donor can be utilized when applied to a carbon black surface, to achieve a similar or equal level of performance improvement than when simply added to a mix.

In various aspects, the sulfur donor can be present in an amount approximately equivalent to greater than 0 phr up to about 15 phr, on the basis of a compounded elastomer mixture. In other aspects, the sulfur donor can be present in an amount from about 2 phr to about 12 phr, depending upon, for example, the specific elastomers, antioxidants, and other components used, and the desired properties of the resulting compound. In still other aspects, the sulfur donor can be present in an amount from about 3 phr to about 9 phr, such as, for example, about 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.7, 5.9, 6.1, 6.3, 6.5, 6.7, 6.9, 7.1, 7.3, 7.5, 7.7, 7.8, 7.9, 8, 8.1, 8.2, 8.3, 8.4, 8.5, 8.6, 8.7, 8.8, 8.9, or 9 phr. In another aspect, the sulfur donor can be present in an amount from about 6 phr to about 9 phr, for example, about 6, 6.5, 7, 7.5, 8, 8.5, or 9 phr. In another aspect, the sulfur donor can be present in an amount from about 4 phr to about 6 phr, for example, about 4, 4.2, 4.4, 4.6, 4.8, 5, 5.2, 5.4, 5.6, 5.8, or 6 phr. It should be noted that any of the above values and/or ranges for the amount of sulfur donor can be used to describe a neat sulfur donor or a supported (i.e., silica supported) sulfur donor, such as, for example, RHENOGRAN SDT/S. In other aspects, the sulfur donor can be sprayed on the surface of a carbon black to a level of from about 2 wt % to about 20 wt % or more (sulfur donor on carbon black), from about 5 wt % to about 15 wt %, from about 8 wt % to about 12 wt %, or about 10 wt %, for example, about 2, 3, 4, 5, 6, 7, 8, 9, 10, 11, 12, 13, 14, 15, 16, 17, 18, 19, or 20 wt % sulfur donor on carbon black.

In various exemplary embodiments, the sulfur donor can be RHENOGRAN SDT/S, present in an amount of from about 4 phr to about 6 phr in an optimized truck/bus radial (TBR) tread composition. In another exemplary embodiment, the sulfur donor can be RHENOGRAN SDT/S, present in an amount of from about 5 phr to about 9 phr in passenger car radial (PCR) tread composition.

It should be noted that the carbon black composition comprising a sulfur donor, can be utilized in any conventional elastomer compound, such as SBR/BR compositions for passenger treads, NR/BR compositions for truck treads, as well as other conventional elastomer compositions not specifically recited herein.

The inventive carbon black composition comprising a sulfur donor can impart one or more improved performance properties to a resulting elastomeric compound. In one aspect, use of the inventive carbon black composition can provide a significant reduction in rolling resistance over comparable conventional elastomer compounds.

In other aspects, use of a sulfur donor, such as, for example, RHENOGRAN SDT, by itself (in the absence of an oxidized carbon black as described herein) can provide, for example, a 15-20% reduction in tan delta as compared to a composition comprising a conventional N234 carbon black. When the inventive combination of a carbon black, such as the oxidized carbon black described herein, and a sulfur donor such as the phosphoryl polysulfide RHENOGRAN SDT/S, is used, a 25-30% reduction in tan delta can be observed at an equal carbon black surface area.

This suprising reduction in tan delta surpasses even the extremely low tan delta observed in silica formulations with the use of a silica coupling agent.

In one aspect, the present disclosure provides a carbon black contacted with a sulfur donor. In another aspect, the carbon black is a functionalized carbon black. In yet another aspect, a functionalized carbon black is contacted with a sulfur donor, such as, for example, a polysulfide. In yet another aspect, the carbon black is oxidized and and is contacted with a sulfur donor comprising a disulfide or trisulfide bond. In yet another aspect, the carbon black is a CD2125XZ grade carbon black, available from Columbian Chemicals Company, Marietta, Ga., USA, contacted with a RHENOGRAN SDT sulfur donor. In another aspect, a functionalized carbon black contacted with a sulfur donor, as described herein, can reduce and/or eliminate the need for a functionalized elastomer, while providing equivalent performance to compositions comprising a functionalized elastomer. In yet another aspect, any of the formulations described or contemplated herein can also comprise silica, for example, at levels of about 2 phr, 4 phr, 6 phr, 8 phr, 10 phr, 12 phr, 14 phr, 16 phr, 18 phr, or 20 phr. In one aspect, silica can be added to a composition comprising a coupled carbon black formulation (e.g., CD2125XZ and SDT) at a level of about 10 phr.

In one aspect, the inventive compositions described herein, such as, for example, a coupled CD2125XZ (CD2125XZ carbon black and SDT sulfur donor) can provide one or more of the following benefits for PCR formulations, as compared to a conventional N234 reference rubber formulation (as described in the Examples): a reduction in tan delta of from about 40% to about 60%, of at least about 40%, of at least about 45%, or of about 45%; an increase in modulus of from about 20% to about 35%, of at least about 20%, of at least about 24%, or of about 24%; an increase in bound rubber of from about 40% to about 70%, of at least about 10%, of at least about 45%, of at least about 50%, of at least about 55%, of at least about 60%, or about 60%, each with less than about 20% impact on crosslink density; and/or a reduction in heat buildup of from about 15% to about 35%, of at least about 15%, of at least about 20%, of at least about 24%, or of about 24%.

The use of coupled N234 can exhibit a reduction in tan delta of about 21%, an increase in modulus of about 19%, an increase in bound rubber of about 40% with similar crosslink density, and a reduction in heat buildup of about 5%. Thus, the use of a sulfur donor with a conventional, non-functionalized carbon black can impart significant improvements to an elastomer formulation. The use of a functionalized carbon black with a sulfur donor, as described herein, can impart even greater improvements to an elastomer formulation.

Similarly, use of a sulfur donor and carbon black in TBR formulations can also provide significant improvements to in-rubber properties. In one aspect, use of a functionalized carbon black (e.g., CD2125XZ) an in NR/BR formulation can allow for the addition of a typical secondary accelerator (e.g., SDT) earlier in the mix than would occur in a conventional rubber compounding process. In another aspect, the crosslink density of a rubber compound comprising the sulfur donor of the present invention can be impacted to a lesser extent with the combination of a functionalized carbon black (e.g., CD2125XZ) and SDT (added to the mix or sprayed on the carbon black surface), as compared to a conventional N234 reference compound. In another aspect, use of a sulfur donor, such as, for example, SDT, can improve the reduction in modulus observed with CD2125XZ in NR containing compounds, as compared to a conventional N234 reference compound. In another aspect, a significant reduction in heat buildup can be observed when utilizing a functionalized carbon black and sulfur donor (e.g., CD2125XZ and SDT). Such reductions in heat buildup can be particularly advantageous in truck tread compounds. In another aspect, Veith tear strength and Knotty tear index for formulations comprising functionalized carbon blacks nad a sulfur donor can be comparable to or higher than those observed for conventional N234 reference compounds. In another aspect, use of a functionalized carbon black and sulfur donor can reduce tan delta by nearly 40% or more when the sulfur donor is sprayed on the surface of the functionalized carbon black, compared to use of the same carbon black without the sulfur donor (i.e., uncoupled). The same approach for a N234 formulation yields only a 30% reduction in tan delta (i.e., coupled vs. uncoupled), indicating a synergistic effect between the functionalized carbon black and the sulfur donor. These large reductions in tan delta are observed, despite higher low-strain G′ values for CD2125XZ/SDT containing formulations. Thus, in one aspect, use of a functionalized carbon black and sulfur donor, as described herein, can provide the ability to tailor the dynamic stiffness of a rubber compound, such as, for example, a truck tread compound, without sacrificing rolling resistance—effectively decoupling tan delta from G′.

Thus, in one aspect, the invention composition can provide performance equivalent to or exceeding that of silica formulations. In addition, the resulting elastomeric compound can exhibit high modulus and crosslink density, while retaining acceptable elongation values.

Such an elastomeric compound can also exhibit lower viscosity than typical compounds using the same oxidized carbon black alone. In addition, the inventive composition can facilitate easy mixing, processing, and extrusion of the elastomer compounds. Such elastomer compounds comprising the inventive composition do not exhibit modulus losses typically seen when using oxidized carbon blacks for NR/BR formulations.

### EXAMPLES

The examples and data attached hereto are put forth so as to provide those of ordinary skill in the art with a complete disclosure and description of how the compounds, compositions, articles, devices, and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. References to N234 are intended to refer to standard ASTM carbon blacks. References to CD2125XZ (and sometimes abbreviated as CD2125) are intended to refer to the inventive carbon black described herein. References to the term “coupled” are intended to refer to instances wherein the carbon black is present with (e.g., SDT added) and/or comprises (e.g., sprayed with SDT) a sulfur donor species, or wherein a silica is present with coupling agent. References to the terms “non-coupled” or “uncoupled” are intended to refer to instances wherein the carbon black is not present with and/or does not comprise a sulfur donor species, as described herein.

### Example 1—Non-Functionalized Passenger Car Formulations

In a first example, a series of rubber formulations suitable for use in a passenger car radial were prepared, as detailed in Table 1, below.

TABLE 1
Non-Functionalized Passenger Car Radial Formulations

| | Uncoupled | Coupled | Uncoupled | Coupled | Uncoupled | Coupled |
|---|---|---|---|---|---|---|
| Component | N234 | N234 | CD2125XZ | CD2125XZ | Silica | Silica |
| SBR-VSL 4526-2 | 96.25 | 96.25 | 96.25 | 96.25 | 96.25 | 96.25 |
| BR-BUNA CB24 | 30 | 30 | 30 | 30 | 30 | 30 |
| Carbon Black | 75 | 75 | 75 | 75 | 3 | 3 |
| Silica | — | — | — | — | 90 | 90 |
| TDAE-Vivatec 500 | 5.75 | 5.75 | 5.75 | 5.75 | 5.75 | 5.75 |
| TESPT | — | — | — | — | — | 7.2 |
| ZnO | 4 | 4 | 4 | 4 | 4 | 4 |
| Steam Acid | 2 | 2 | 2 | 2 | 2 | 2 |
| Microwax | 2.5 | 2.5 | 2.5 | 2.5 | 2.5 | 2.5 |
| 6PPD | 2 | 2 | 2 | 2 | 2 | 2 |
| TMQ | 2 | 2 | 2 | 2 | 2 | 2 |
| Aflux 37 | — | — | — | — | 3 | 3 |
| Rhenogran SDT | — | 8.4 | — | 8.4 | — | — |
| (Additive or Spray) | | | | | | |
| CLD-80 | — | — | — | — | — | — |
| Sulfur | 1.9 | 1.0 | 1.9 | 1.0 | 1.6 | 1.6 |
| TBBS | 1.5 | 0.6 | 1.5 | 0.6 | 1.6 | 1 6 |
| DPG | — | — | 1.5 | 0.6 | 2.75 | 2.75 |
| PVI | — | 0.3 | — | 0.3 | 0.2 | 0.2 |

In Table 1, above, formulations were prepared using uncoupled and coupled versions of a conventional ASTM N234 grade carbon black, a CD2125XZ grade carbon black (available from Columbian Chemicals Company, Marietta, Ga., USA), and silica. Other components utilized in one or more the formulations include: SBR-VSL 4526-2, a solution styrene butadiene polymer, available from ARLANXEO Performance Elastomers, Germany; BR-BUNA® CB24, a butadiene rubber, also available from ARLANXEO Performance Elastomers, Germany; TDAE-Vivatec 500, a process oil, available from Hansen & Rosenthal KG, Hamburg, Germany; TESPT, a bis (3-triethoxysilylpropyl) testrasulphane silane coupling agent, available from Hansen & Rosenthal KG, Hamburg, Germany; 6PPD, a N-(1,3-Dimethylbutyl)-N′-phenyl-p-phenylenediame antioxidant, available from Eastman Santoflex, USA; TMQ, a 2,2,4-Trimethyl-1,2-Dihydroquinoline polymer antioxidant, available from Shandong Stair Chemical & Technology Co., Ltd., Shandong, China; AFLUX® 37, a process promoter for silica compounds, available from Lanxess Rhein Chemie, Cologne, Germany; RHENOGRAN® SDT, a sulfur donor, available from Lanxess Rhein Chemie, Cologne, Germany; RHENOGRAN® CLD-80, a caprolactam disulfide, available from Lanxess Rhein Chemie, Cologne, Germany; TBBS, a N-tert-Butyl-2-Benzothiazolesulfenamide cure accelerator, available from Linkwell Rubber Chemicals Company, Qingdao, China; DPG, a diphenyl guanidine accelerator, available from Akrochem Corporation, Akron, Ohio, USA; and PVI, a N-cyclohexy(thio) phthalimide anti-scorch retarder, available from Nocil Limited, Mumbai, India. Other components are those commonly used and widely available in the rubber industry, including ZnO (zinc oxide), stearic acid, microwax (microcrystalline wax), and sulfur. Each of the values recited in Table 1 refer to the phr concentration.

The mixing protocol for the formulations in Table 1 containing ASTM N234 grade carbon black or CD2125XZ grade carbon black is listed below, in Table 2.

TABLE 2
Mixing Protocol for Carbon Black PCR Formulations

| | Time | Temp | | |
|---|---|---|---|---|
| Pass | (sec) | (° C.) | RPM | Process |
| 1 | 30 | 80 | 70 | Load: Polymer |
| 1 | 60 | 80 | 70 | Load: ⅔ Carbon Black |
| 1 | 120 | 80 | 70 | Load: Oil, ⅓ CB (blended) |
| 1 | 180 | 150 | Var. | Load: Chemicals and SDT - |
| | | | | Reactive Feedback to 150° C. |
| 1 | ~400 | — | 70 | Ram Down Discharge |

Mill: 70° C., 25:21 rpm, Gap 0.055-60″

| | | | | |
|---|---|---|---|---|
| 2 | 180 | 25 | 60 | Load: ½ MB, Cures, ½ MB |
| 2 | ~190 | — | 45 | Discharge (100° C. Max) |

Mill: 70° C., 25:21 rpm, Gap 0.055-60″

The mixing protocol for the formulations in Table 1 containing silica is listed below, in Table 3.

TABLE 3
Mixing Protocol for Silica PCR Formulations

| | Time | Temp | | |
|---|---|---|---|---|
| Pass | (sec) | (° C.) | RPM | Process |
| 1 | 30 | 80 | 70 | Load: Polymer |
| 1 | 60 | — | 70 | Load: ⅔ Silica, Carbon Black, ⅔ |
| | | | | Silane (blended), Sweep |
| 1 | 90 | 120 | Var. | Load: ⅓ Silica, Oil (blended) - Reactive |
| | | | | Feedback to 120° C. |
| 1 | 15 | — | 70 | Load: Chemicals, Sweep |
| 1 | 30 | 150 | Var. | Mixing - Reactive Feedback to 150° C. |
| 1 | 180 | 160 | Var. | Mixing - Reactive Feedback to 160° C. |
| 1 | ~400 | — | 70 | Ram Down Discharge |

Mill: 70° C., 25:21 rpm, Gap 0.055-60″

| | | | | |
|---|---|---|---|---|
| 2 | 30 | 80 | 70 | Load: Masterbatch |
| 2 | 30 | 150 | Var. | Mixing - Reactive Feedback to 150° C. |
| 2 | 180 | 160 | Var. | Mixing - Reactive Feedback to 160° C. |
| 2 | ~250 | — | 70 | Ram Down Discharge |

Mill: 70° C., 25:21 rpm, Gap 0.055-60″

| | | | | |
|---|---|---|---|---|
| 3 | 180 | 25 | 60 | Load: ½ MB, Cures, ½ MB |
| 3 | ~190 | — | 45 | Discharge (100° C. Max) |

Mill: 70° C., 25:21 rpm, Gap 0.055-60″

It should be noted that the formulations containing silica required an additional reactive mixing pass.

### Example 2—Evaluation of PCR Formulations

In a second example, a series of evaluations was performed on each of the PCR formulations prepared in Example 1, above. Dispersion measurements were obtained according to ASTM D2263 and compared for each of the PCR formulations described in Table 1. The dispersion results were comparable for each of the formulations, including both the uncoupled and coupled versions.

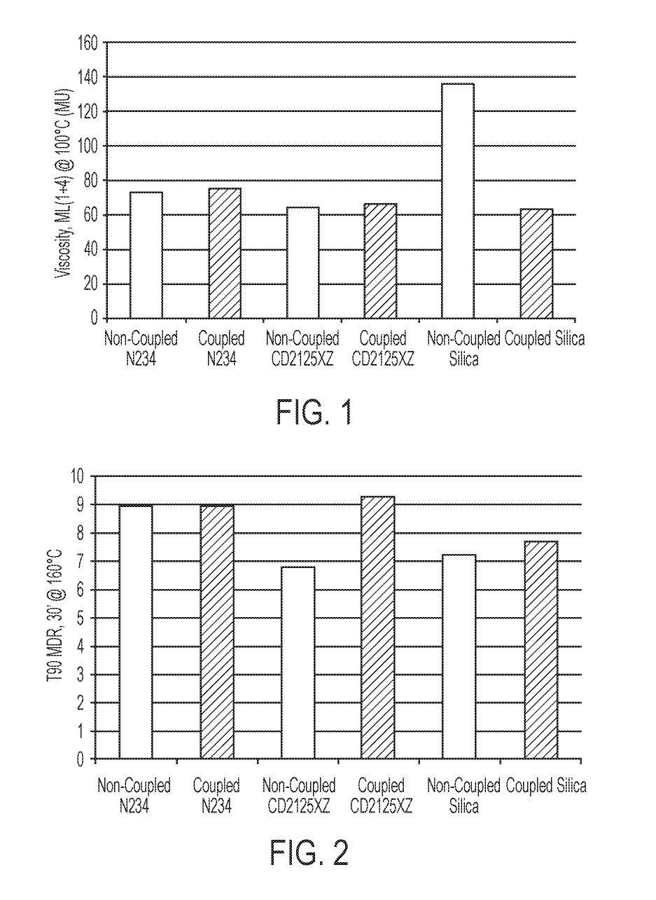

The Mooney viscosity of each of the formulations was measured using ASTM D1646. The Mooney viscosity was relatively constant for all of the carbon black containing formulations and for the coupled silica containing formulation, but was significantly increased for the uncoupled silica formulation, as illustrated in FIG. 1. Scorch times, also measured using ASTM D1646, were reduced for formulations containing coupling agents. The optimal vulcanization time (T90) for the formulations, as determined by ASTM D5289, are illustrated in FIG. 2, wherein the T90 is slightly increased for the coupled CD2125XZ formulation, making it roughly equivalent to a conventional N234 containing formulation.

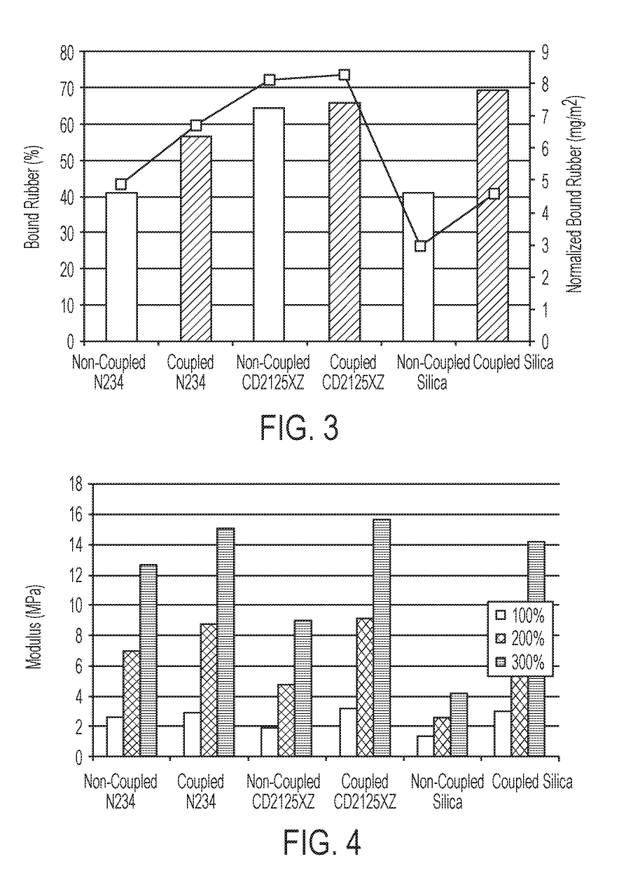

Moving die rheometer (MDR) results at 160° C., as determined by ASTM D5289, showed typical and expected torque vs. time curves for each of the carbon black containing formulations and for the coupled silica containing formulation. Results for the uncoupled silica formulation were indicative of severe flocculation. Bound rubber measurements were also obtained for each of the PCR formulations. The percentage of bound rubber was significantly reduced for the uncoupled silica formulation, in contrast to the formulations containing N234 or CD2125XZ carbon black. The high bound rubber values for the CD2125XZ carbon black containing formulations was not dependent on the particular coupling agent used in the formulation. When the bound rubber values were normalized for loading and surface area, the values for the silica formulations, especially for the uncoupled silica, were significantly lower, as illustrated in FIG. 3.

The crosslink density increased for each of the coupled PCR formulations, but the amplitude of the increase for the silica containing formulation was significantly higher than that of either of the carbon black containing formulations. Shore A Hardness values for the PCR formulations, as determined by ASTM D2263, were comparable for both the coupled and uncoupled CD2125XZ formulations and for the uncoupled silica formulation, as compared the the standard N234 formulation.

The modulus build (100% to 200% to 300%) of the PCR formulations, as determined by ASTM D412, increases significantly with the presence of a coupling agent for the carbon black containing and silica containing formulations, as illustrated in FIG. 4. The coupled CD2125XZ formulation recovers the low modulus of the uncoupled CD2125XZ formulation and exceeds that of the N234 formulations. Elongation measurements (i.e., % elongation), also determined by ASTM D412, show a decrease in elongation for each of the PCR formulations with the addition of a coupling agent, but the ultimate elongation values remained acceptable for use in PCR formulations. Similarly, the tensile strength, also determined by ASTM D412, remained relatively constant upon addition of a coupling agent to the carbon black containing PCR formulations. Upon addition of a coupling agent to the silica containing PCR formulation, the tensile strength increased by almost 50%.

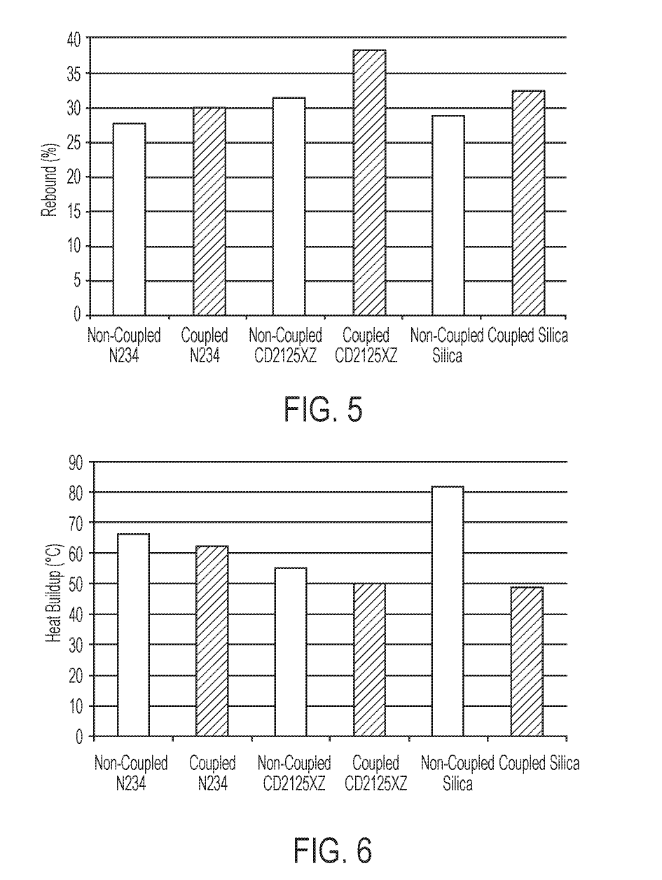

Rebound values at 25° C. (FIG. 5) and at 60° C., as determined by ASTM D7121, were higher for each of the coupled formulations relative to their uncoupled counterparts, and highest for the CD2125XZ containing formulation.

Heat buildup was reduced for each of the coupled formulations relative to their uncoupled counterpart, as illustrated in FIG. 6. It should be noted that the uncoupled silica containing formulation exhibited an exceptionally high heat buildup.

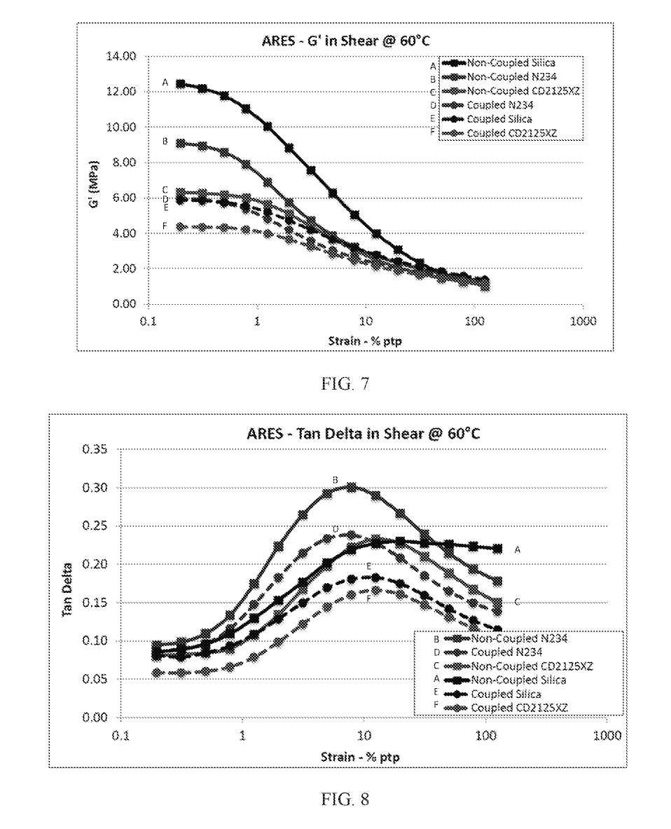

When measuring G′ (MPa) in shear at 60° C. using an ARES Rheometer, the coupled silica formulation exhibited a significant drop in Payne Effect, as illustrated in FIG. 7. The CD2125XZ formulation exhibited a moderate drop, but maintained the lowest shear modulus across the measured strains. While the CD2125XZ formulation exhibited a smaller drop in Payne Effect, this formulation exhibited a larger drop in tan delta (shear at 60° C.), as compared to the silica formulations, and a greater than 50% reduction as compared to the N234 formulation, as illustrated in FIG. 8.

A summary of the in-rubber test properties for the PCR formulations described in Example 1 is detailed in Table 4, below. Values in Table 4 represent the percent difference as compared to an uncoupled N234 formulation.

TABLE 4
Summary of In-Rubber Properties (% difference
compared to uncoupled N234)

| | | Uncoupled | Coupled | Uncoupled | Coupled | Uncoupled | Coupled |
|---|---|---|---|---|---|---|---|
| Test | Unit | N234 | N234 | CD2125XZ | CD2125XZ | Silica | Silica |
| Mooney | | | | | | | |
| Viscosity, ML(1 + 4) @, 100° C. | MU | 100 | 103 | 88 | 89 | 185 | 85 |
| MDR, 30′ @, 160° C. | | | | | | | |
| Min | dNm | 100 | 104 | 90 | 83 | 251 | 64 |
| Max | dNm | 100 | 102 | 85 | 101 | 199 | 108 |
| Max-Min | dNm | 100 | 102 | 84 | 105 | 187 | 118 |
| T90 | Min | 100 | 100 | 76 | 103 | 81 | 86 |
| Tensile Properties | | | | | | | |
| 100% Modulus | MPa | 100 | 112 | 74 | 124 | 52 | 113 |
| 200% Modulus | MPa | 100 | 125 | 67 | 130 | 37 | 111 |
| 300% Modulus | MPa | 100 | 119 | 71 | 124 | 33 | 113 |
| Bound Rubber | % | 100 | 138 | 158 | 161 | 100 | 170 |
| Crosslink Density | moles/cm³ | 100 | 118 | 86 | 117 | 82 | 193 |
| Rebound @ 25° C. | % | 100 | 109 | 113 | 137 | 104 | 117 |
| Rebound @ 60° C. | % | 100 | 113 | 115 | 137 | 108 | 125 |
| Heat Buildup | ° C. | 100 | 95 | 83 | 76 | 124 | 74 |
| ARES Strain Sweep | | | | | | | |
| Tan Delta | — | 100 | 79 | 78 | 55 | 77 | 61 |
| Delta G′ | MPa | 100 | 61 | 74 | 45 | 152 | 62 |

Thus, in some instances, the coupled CD2125XZ carbon black formulation (i.e., CD2125XZ with sulfur donor) can exhibit performance similar to that obtained for silica and/or silane formulations, by acting as a chemical crosslink in a non-functionalized rubber compound. The addition of the sulfur donor species to the CD2125XZ carbon black had a negligible impact on the Mooney viscosity, cure kinetics, and state of cure (i.e., bound rubber and crosslink density) of a resulting rubber compound, while simultaneously improving the static modulus, tensile strength, heat buildup, and tan delta. The tan delta can be reduced by 30%, as compared to uncoupled CD2125XZ (i.e., CD2125XZ alone without the sulfur donor) and by more than 50%, as compared to a conventional N234 formulation. Accordingly, use of a sulfur donor species, as described here, in combination with carbon black in a rubber formulation, can provide rubber compound benefits typically associated with carbon black, while improving hysteresis for better rolling resistance.

The synergistic combination of carbon black and a sulfur donor species, as described herein, can provide the typical benefits of a carbon black (e.g., N234) filled elastomer, combined with low rolling resistance typically only achieved in silica formulations.

### Example 3—Truck Bus Radial Formulations

In a third example, a series of rubber formulations suitable for use in truck/bus radial (TBR) tires were prepared using various combinations of N234 grade carbon black, CD2125XZ grade carbon black, silica, and SDT sulfur donor species, as detailed in Table 5 below.

TABLE 5
TBR Formulations Using Sulfur Donor

| | | | | | | | | 8 |
|---|---|---|---|---|---|---|---|---|
| | 1 | | 3 | 9 | | | 6 | 10% SDT- |
| | N234 | 2 | 10% SDT- | 10% SDT- | 4 | 5 | 10% SDT- | Sprayed |
| | Reference | SDT-Added | Sprayed | Sprayed | CD2125XZ | SDT-Added | Sprayed | CD2125XZ/ |
| | in | N234 in | N234 in | N234/SiO2 in | Reference in | CD2125XZ in | CD2125XZ in | SiO2 in |
| Component | NR/BR | NR/BR | NR/BR | NR/BR | NR/BR | NR/BR | NR/BR | NR/BR |
| NR-SMR CV 60 | 80 | 80 | 80 | 80 | 80 | 80 | 80 | 80 |
| BR-Budene 1207 | 20 | 20 | 20 | 20 | 20 | 20 | 20 | 20 |
| N234 | 50 | 50 | 50 | 47.5 | — | — | — | — |
| CD2125XZ | — | — | — | — | 52 | 52 | 52 | 49.5 |
| Silica | — | — | — | 10 | — | — | — | 10 |
| TDAE-Vivatec 500 | 4 | 4 | 4 | 4 | 4 | 4 | 4 | 4 |
| ZnO | 4 | 4 | 4 | 4 | 4 | 4 | 4 | 4 |
| Stearic Acid | 2 | 2 | 2 | 2 | 2 | 2 | 2 | 2 |
| Microwax | 2 | 2 | 2 | 2 | 2 | 2 | 2 | 2 |
| 6PPD | 2 | 2 | 2 | 2 | 2 | 2 | 2 | 2 |
| TMQ | 1 | 1 | 1 | 1 | 1 | 1 | 1 | 1 |
| Rhenogran SDT | — | 5.60 | 5.60 | 5.60 | — | 5.60 | 5.60 | 5.60 |
| (Additive or Spray) | | | | | | | | |
| Sulfur | 1 | 0.7 | 0.7 | 0.7 | 1 | 0.7 | 0.7 | 0.7 |
| TBBS | 1.8 | 0.9 | 0.9 | 0.9 | 1.8 | 0.9 | 0.9 | 0.9 |
| DPG | — | — | — | — | 1.5 | 0.35 | 0.35 | 0.35 |
| PVI | — | 0.3 | 0.3 | 0.3 | — | 0.3 | 0.3 | 0.3 |

In Table 5, above, formulations were prepared using uncoupled and coupled versions of a conventional ASTM N234 grade carbon black, a CD2125XZ grade carbon black (available from Columbian Chemicals Company, Marietta, Ga., USA), and silica. Other compents utilized in one or more the formulations include: NR-SMR CV60, a constant viscosity Standard Malaysian Rubber (natural rubber), available from Akrochem Corporation, Akron, Ohio, USA; and BUDENE 1207, a butadiene rubber (BR), available from Goodyear Chemical, Houston, Tex., USA. Other components utilized in one or more formulations are described in Example 1, above. Sample 1 is a reference NR/BR rubber formulation containing N234 grade carbon black. Sample 2 is similar to Sample 1, but contains a sulfur donor species (i.e., RHENOGRAN SDT). Sample 3 utilizes N234 grade carbon black sprayed with SDT, to a level of 10 wt % of SDT based on the carbon black weight. Sample 9 utilizes a mixture of a N234 grade carbon black sprayed SDT (10 wt % SDT on carbon black), and silica. Sample 4 utilizes a CD2125XZ grade carbon black in a NR/BR blend without the addition of a sulfur donor. Sample 5 is similar to Sample 4, but contains a sulfur donor species. Sample 6 utilizes a CD2125XZ grade carbon black, sprayed with SDT (10 wt % SDT on carbon black). Sample 8 utilizes a mixture of a CD2125XZ grade carbon black sprayed with SDT (10 wt % SDT on carbon black), and silica.

The mixing protocol for the TBR formulations described above are detailed in Table 6, below.

TABLE 6
TBR Mixing Protocol
Birla Carbon TBR Mixing Protocol

| | Time | Temp | | |
|---|---|---|---|---|
| Pass | (sec) | (° C.) | RPM | Process |
| 1 | 60 | 40 | 77 | Load: NR, ½ CB and Chemicals |
| | | | | (including SDT), BR |
| 1 | 60 | 40 | 77 | Load: Oil, ½ CB (blended) |
| 1 | 180 | 40 | 77 | Ram Down Mixing (90 sec - sweep - 90 sec) |
| 1 | ~300 | — | 77 | Discharge (150° C. Max - Slow |
| | | | | RPM if necessary) |

Mill: 70° C., 25:21 rpm, Gap 0.055-60″

| | | | | |
|---|---|---|---|---|
| 2 | 30 | 25 | 60 | Load: ½ MB, Cures, ½ MB |
| 2 | 30 | 25 | 45 | Sweep |
| 2 | 120 | 25 | 45 | Ram Down Mixing |
| 2 | ~180 | — | 45 | Discharge (100° C. Max - Slow |
| | | | | RPM if necessary) |

Mill: 70° C., 25:21 rpm, Gap 0.055-60″

### Example 4—Evaluation of TBR Formulations

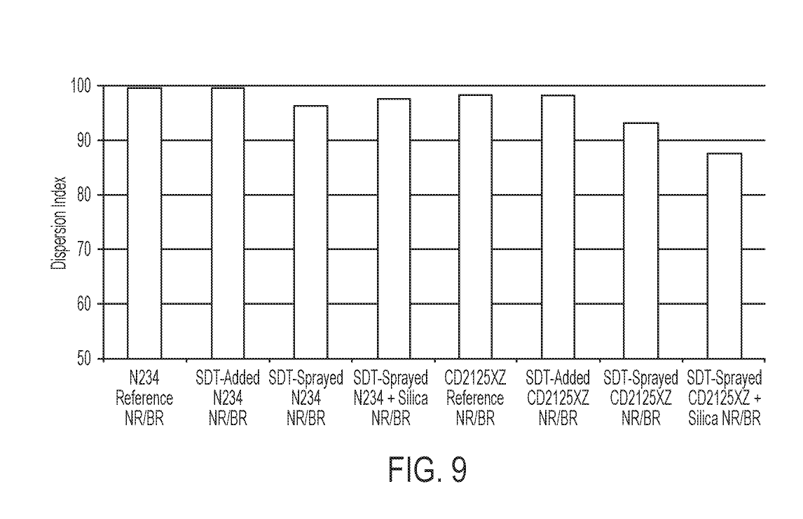

In a fourth example, a series of evaluations was performed on each of the TBR formulations prepared in Example 3, above. Dispersion measurements were obtained according to ASTM D2263 and compared for each of the TBR formulations described in Table 5. The dispersion results were comparable for each of the formulations, including both the uncoupled and coupled versions, except that the dispersion index was slightly reduced for Sample 12 (SDT-sprayed CD2125XZ with uncoupled silica), as illustrated in FIG. 9.

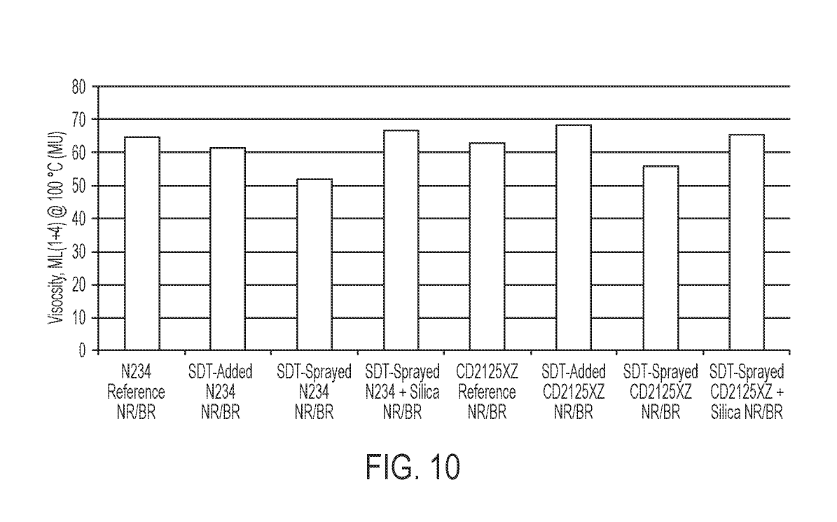

FIG. 10 illustrates the Mooney viscosity of each of the TBR formulations, as determined by ASTM D1646. Mooney viscosity values were reduced for the SDT sprayed samples, as compared to their counterparts where the SDT was introduced as an additive. The addition of uncoupled silica can also increase viscosity to a range similar to that of the reference N234 NR/BR formulation.

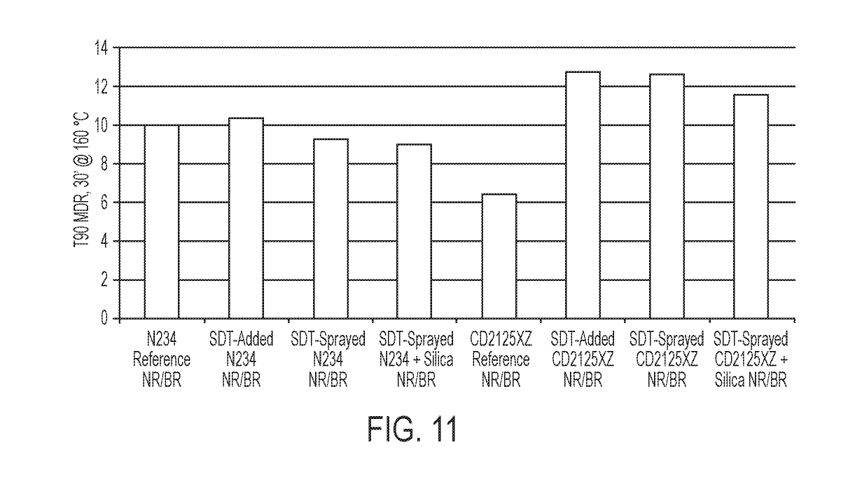

Scorch times, also measured using ASTM D1646, were reduced with the addition of SDT. The T90 cure time, illustrated in FIG. 11, is increased for formulations containing CD2125XZ and SDT. In these samples, the secondary accelerator concentration was reduced to compensate for the additional sulfur present in the SDT. While not wishing to be bound by theory, it is believed that the amount of secondary accelerator can be further optimized to improve T90 cure time for these samples. Despite the increase in T90 cure time, the final state of cure for these samples was not impacted in a significant manner.

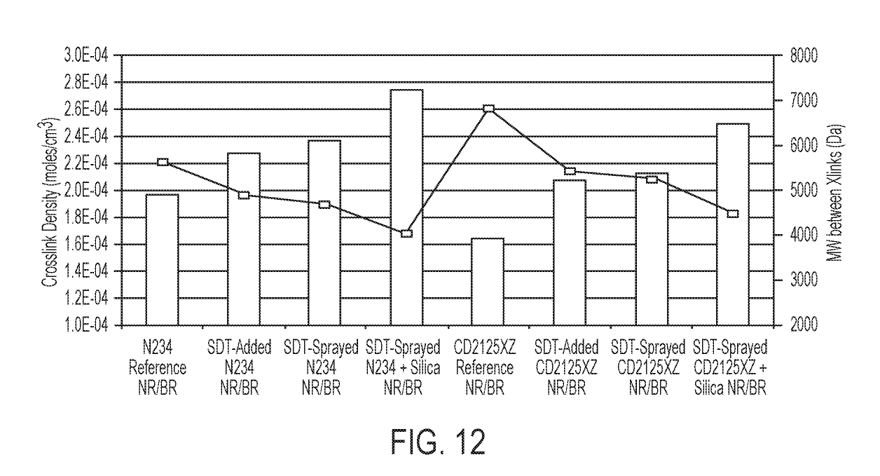

Bound rubber measurements were relatively constant for each of the TBR formulations, but were slightly reduced for Sample 3 (N234 sprayed with SDT), potentially indicating that the SDT is preventing filler-elastomer interaction at the non-functionalized surface of the N234 carbon black. The crosslink density, illustrated in FIG. 12, increased for each of the SDT containing formulations, but to a greater extent for the N234 containing formulations. Samples 8 and 9 that contain SDT sprayed carbon black and uncoupled silica, both exhibited the highest level of crosslink density, believed to be due to reduced curative scavenging. Shore A Hardness values were reduced for the TBR formulations containing SDT, but to a similar level as the corresponding reference with the addition of uncoupled silica.

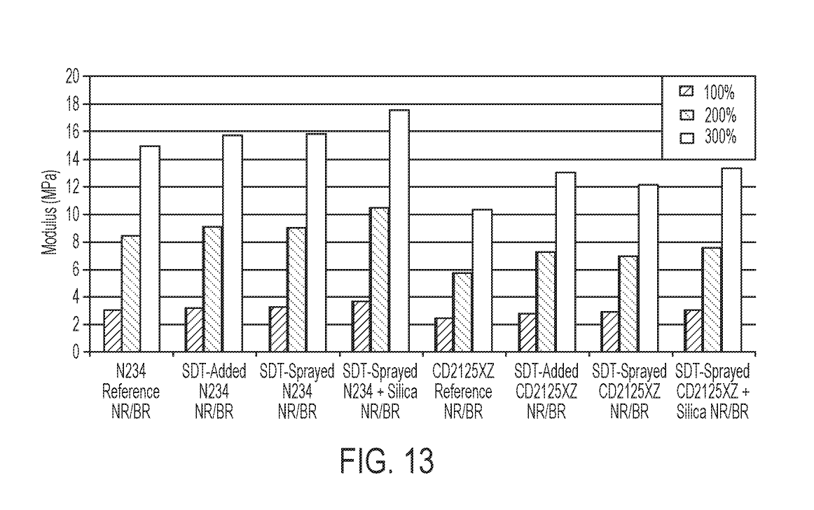

The modulus build (100% to 200% to 300%) of the TBR formulations, as determined by ASTM D412, increases with the addition of SDT, as illustrated in FIG. 13. The formulations containing CD2125XZ maintained a lower modulus than the N234 reference formulations. Elongation measurements (i.e., % elongation), also determined by ASTM D412, show a decrease in elongation for each of the TBR formulations upon the addition of SDT, and even a larger decrease for those formulations wherein the SDT was sprayed on the carbon black. While not wishing to be bound by theory, it is believed that the level of sulfur donor species (e.g., SDT) can further be optimized to maintain and/or improve elongation for a given formulation. Similarly, the tensile strength, also determined by ASTM D412, is slightly reduced for each of the SDT containing formulations, as a result of the reduced elongation values.

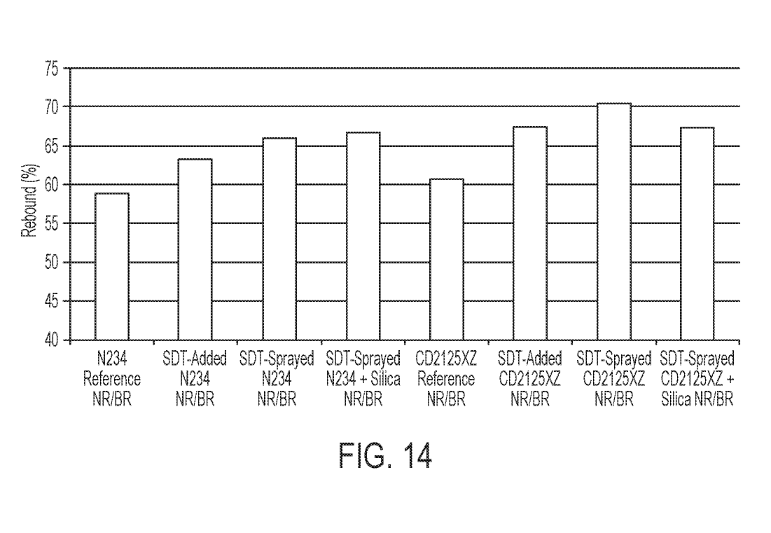

Rebound values at 25° C., as determined by ASTM D7121, were highest for the SDT-sprayed CD2125XZ containing TBR formulations. Each of the SDT containing formulations exhibited higher rebound values than their non-SDT containing counterparts. Rebound values at 60° C., as illustrated in FIG. 14, increased for all SDT containing formulations, with the SDT sprayed CD2125XZ formulation exhibiting the highest rebound value. The presence of uncoupled silica can have a slightly negative impact on the rebound of CD2125XZ containing formulations, but can improve rebound N234 containing formulations.

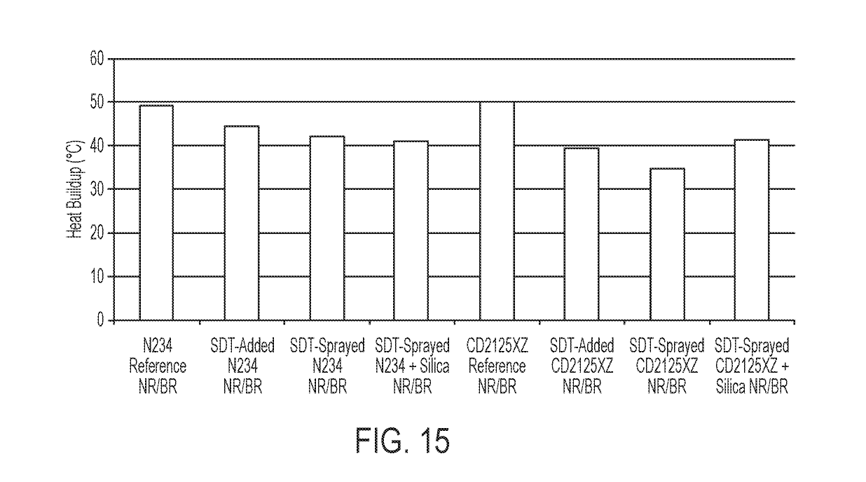

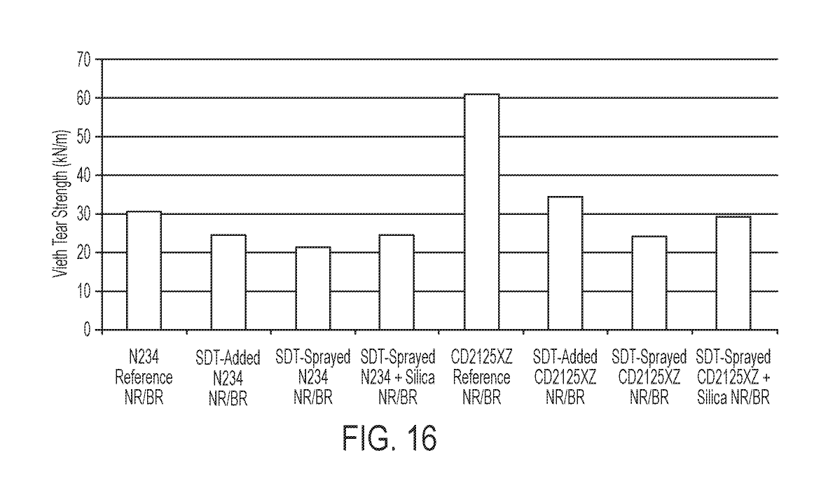

Heat buildup, as illustrated in FIG. 15, was significantly reduced for the TBR formulations containing both CD2125XZ and SDT. A reduction in Vieth tear strength was observed for all SDT containing TBR formulations, as illustrated in FIG. 16, but each of the CD2125XZ containing formulations exhibited higher Vieth tear strength than their N234 counterparts. Similarly, the Knotty tear index illustrates (FIG. 17) similar trends to Vieth tear strength; however, the SDT-sprayed CD2125XZ formulations are closer in comparison to their N234 counterparts (than with Vieth tear strength).

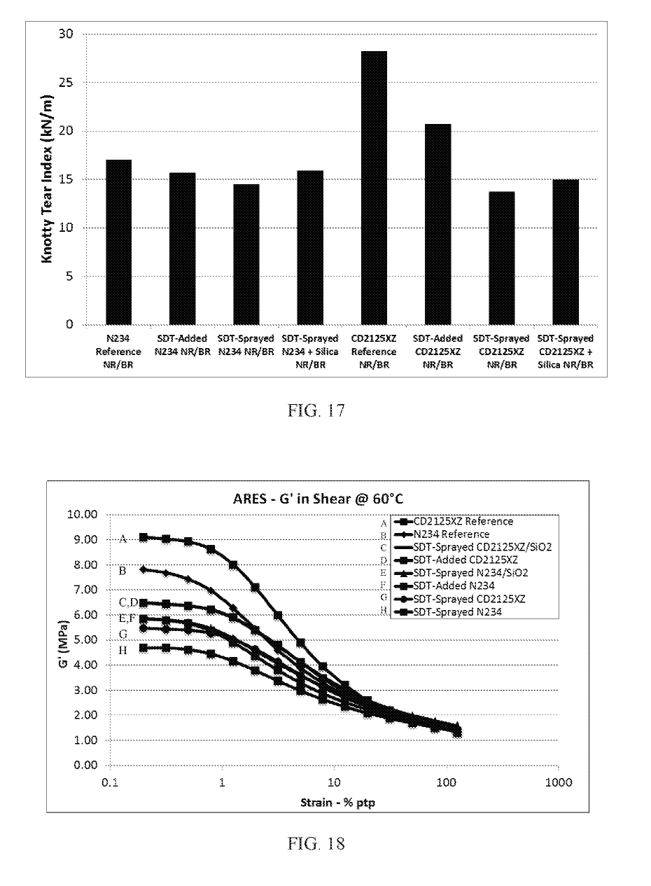

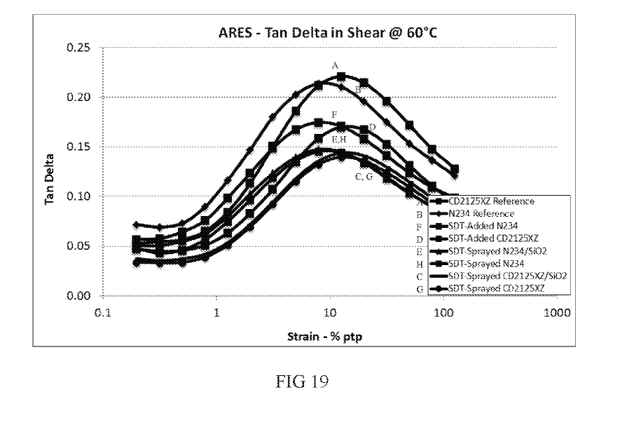

When measuring G′ (MPa) in shear at 60° C. using an ARES Rheometer, the SDT-sprayed carbon black samples exhibited a significant reduction in Payne Effect, as compared to the N234, CD2125XZ, and silica reference formulations not sprayed with SDT (FIG. 18). The CD2125XZ containing formulations exhibited a higher low-strain G′, as compared to their N234 counterparts. As illustrated in FIG. 19, the SDT-sprayed CD2125XZ formulation exhibited a nearly 40% reduction in tan delta. It was also observed that the CD2125XZ containing formulations exhibited a lower tan delta than the N234 formulations, even with higher low-strain G′.

A summary of the in-rubber test properties for the TBR formulations described in Example 3 is detailed in Table 7, below. Values in Table 7 represent the percent difference as compared to an uncoupled N234 formulation.

TABLE 7
Summary of In-Rubber Properties (% difference compared to uncoup

| | | | | | 9 | | | | 8 |
|---|---|---|---|---|---|---|---|---|---|
| | | | 2 | 3 | SDT | | 5 | 6 | SDT |
| | | 1 | SDT | SDT | Sprayed | 4 | SDT | SDT | Sprayed |
| | | N234 | Added | Sprayed | N234 + | CD2125XZ | Added | Sprayed | CD2125XZ + |
| | | Reference | N234 | N234 | Silica | Reference | CD2125XZ | CD2125XZ | Silica |
| Test | Unit | NR/BR | NR/BR | NR/BR | NR/BR | NR/BR | NR/BR | NR/BR | NR/BR |
| Mooney | | | | | | | | | |
| Viscosity, ML (1 + 4) | MU | 100 | 95 | 81 | 103 | 97 | 105 | 86 | 101 |
| @ 100° C. | | | | | | | | | |
| MDR, 30′ @ 160° C. | | | | | | | | | |
| Min | dNm | 100 | 96 | 80 | 98 | 94 | 97 | 77 | 92 |
| Max | dNm | 100 | 105 | 106 | 111 | 93 | 103 | 105 | 114 |
| Max-Min | dNm | 100 | 107 | 111 | 113 | 93 | 104 | 110 | 118 |
| T90 | Min | 100 | 104 | 93 | 90 | 65 | 127 | 127 | 116 |
| Tensile Properties | | | | | | | | | |
| 100% Modulus | MPa | 100 | 106 | 107 | 123 | 82 | 92 | 94 | 100 |
| 200% Modulus | MPa | 100 | 107 | 107 | 123 | 68 | 86 | 82 | 89 |
| 300% Modulus | MPa | 100 | 105 | 106 | 118 | 69 | 87 | 81 | 90 |
| Bound Rubber | % | 100 | 101 | 82 | 104 | 93 | 96 | 101 | 91 |
| Crosslink Density | moles/ | 100 | 115 | 120 | 139 | 83 | 105 | 108 | 126 |
| | cm³ | | | | | | | | |
| MW between crosslinks | Da | 100 | 87 | 83 | 72 | 121 | 96 | 94 | 79 |
| Knotty Tear Index | kN/m | 100 | 92 | 85 | 93 | 165 | 121 | 81 | 88 |
| Veith Tear Strength | kN/m | 100 | 80 | 70 | 80 | 199 | 113 | 87 | 97 |
| Rebound @ 25° C. | % | 100 | 107 | 112 | 112 | 102 | 114 | 122 | 116 |
| Rebound @ 60° C. | % | 100 | 107 | 112 | 113 | 103 | 114 | 119 | 114 |
| Heat Buildup | ° C. | 100 | 91 | 86 | 83 | 102 | 80 | 70 | 84 |
| ARES Strain Sweep | | | | | | | | | |
| Tan Delta | — | 100 | 82 | 68 | 69 | 103 | 79 | 65 | 67 |
| Delta G′ | MPa | 100 | 71 | 55 | 69 | 132 | 87 | 69 | 83 |

Thus, the use of a functionalized carbon black, such as, for example, a CD2125XZ carbon black, in an NR/BR formulation can allow for the addition of a typical secondar accelerator, such as SDT, earlier in the mix cycle than would normally occur. When using a sulfur donor species, such as SDT, is used in combination with a functionalized carbon black, such as, for example, CD2125XZ, there is little impact on the crosslink density of a resulting rubber compound. When the SDT is sprayed on CD2125XZ, the crosslink density is comparable to a conventional N234 reference rubber compound.

In another aspect, the presence of a sulfur donor species, such as SDT, can improve the reduction in modulus observed with CD2125XZ carbon black in NR containing formulations, as compared to N234 containing formulations. A significant reduction in heat buildup can also be observed for SDT and CD2125XZ containing rubber compounds. This reduction in heat buildup can be particularly advantageous for TBR applications, such as truck tread compounds.

Tear properties, such as Vieth tear strength and the Knotty tear index were comparable or higher for SDT-CD2125XZ formulations than for their N234 formulation counterparts.

For SDT-sprayed CD2125XZ containing formulations, tan delta can be reduced by nearly 40%, as compared to uncoupled CD2125XZ materials alone. For N234 based formulations, a 30% reduction is observed, indicating a potential synergistic interaction between the functionalized carbon black (e.g., CD2125XZ) and the sulfur donor species (e.g., SDT). This large reduction in tan delta occurs despite the higher low-strain G′ for CD2125XZ containing formulations with SDT compared to their N234 counterparts.

The use of a sulfur donor, such as SDT, and a functionalized carbon black, such as CD2125XZ, can provide the ability to tailor the dynamic stiffness of, for example, a truck tire without sacrificing rolling resistance. In another aspect, the use of a sulfur donor and a functionalized carbon black can act to decouple G′ from tan delta.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A composition comprising carbon black and a sulfur donor.

2. The composition of claim 1, wherein the sulfur donor comprises a thiophosphate.

3. The composition of claim 1, wherein the sulfur donor comprises a dithiophosphate.

4. The composition of claim 1, wherein the sulfur donor comprises a phosphoryl polysulfide.

5. The composition of claim 1, wherein the carbon black comprises a functionalized carbon black.

6. The composition of claim 1, wherein the carbon black comprises an oxidized carbon black.

7. The composition of claim 1, wherein the carbon black is ozonated.

8. The composition of claim 1, wherein the carbon black has a nitrogen surface area of from about 15 m²/g to about 140 m²/g.

9. (canceled)

10. (canceled)

11. The composition of claim 1, wherein the carbon black has an external surface area of from about 10 m²/g to about 140 m²/g.

12. (canceled)

13. (canceled)

14. The composition of claim 1, wherein the carbon black has an oil absorption number of from about 40 cm³/100 g to about 180 cm³/100 g.

15. (canceled)

16. (canceled)

17. (canceled)

18. The composition of claim 1, wherein the carbon black has a compressed oil absorption number of from about 91 cm³/100 g to about 199 cm³/100 g.

19. (canceled)

20. The composition of claim 1, wherein the carbon black has a moisture content of from about 0.5 wt % to about 10 wt %.

21. The composition of claim 1, wherein the carbon black has a volatile content of from about 1 wt % to about 7 wt %.

22. (canceled)

23. (canceled)

24. The composition of claim 1, wherein the carbon black has an oxygen content of from about 0.5 wt % to about 6 wt %.

25. (canceled)

26. The composition of claim 1, wherein the sulfur donor is present on the surface of the carbon black.

27. (canceled)

28. An elastomer composition comprising the composition of claim 1.

29. The elastomer composition of claim 28, wherein the sulfur donor is present at a concentration of from greater than 0 phr to about 15 phr.

30. (canceled)

31. (canceled)

32. (canceled)

33. The elastomer composition of claim 28, wherein the composition comprises a passenger car radial rubber composition.

34. The elastomer composition of claim 28, wherein the composition comprises a truck bus radial rubber composition.

35. A method for preparing a carbon black composition comprising a sulfur donor, comprising contacting the carbon black and the sulfur donor.

36. The method of claim 35, wherein the sulfur donor is sprayed on the surface of the carbon black.

37. (canceled)

38. (canceled)

39. The method of claim 35, wherein the carbon black and sulfur donor are contacted prior to contacting any one or more elastomer materials.

40. (canceled)

41. (canceled)

42. The method of claim 39, wherein the one or more elastomer materials are not functionalized.

43. A method for preparing a rubber compound, comprising contacting a carbon black and a sulfur donor, and then contacting with elastomer.

44. The method of claim 43, wherein no reactive mixing is required to prepare the rubber compound.

45. A rubber compound prepared according to the method of claim 35.

46. (canceled)

47. (canceled)

48. (canceled)

49. (canceled)

50. (canceled)

51. (canceled)

52. (canceled)
